(19) United States
(12) Patent Application Publication
(10) Pub. No.: US 2012/0177119 A1
(43) Pub. Date: Jul. 12, 2012

(54) FASTER MOTION ESTIMATION IN AN AVC SOFTWARE ENCODER USING GENERAL PURPOSE GRAPHIC PROCESS UNITS (GPGPU)

(75) Inventors: Saritha Dwarakapuram, San Jose, CA (US); Tsaifa Yu, Milpitas, CA (US); Masahito Yamane, Kawasaki (JP)

(73) Assignee: Sony Corporation

(21) Appl. No.: 12/986,604

(22) Filed: Jan. 7, 2011

(51) Int. Cl. H04N 7/12

(52) U.S. Cl. 375/240.16; 375/E07.104; 375/E07.026; 375/E07.243

(57) ABSTRACT

Systems and methods consistent with the invention relate to performing faster motion estimation through efficient use of the General Purpose Graphic Processing Unit (GPGPU) as the compute co-processor in a multi-processor architecture. Integer pel motion estimation and fractional pel motion estimation algorithms for large block sizes may be performed on the GPU, while motion estimation for smaller block sizes is performed on the central processing unit (CPU). In embodiments described herein, GPU-based integer pel motion estimation and fractional pel motion estimation algorithms are performed using kernels which are designed so that multiple thread blocks can run concurrently on a multiprocessor.

### TECHNICAL FIELD

The present disclosure relates to methods and systems for performing motion estimation in H.264/Advanced Video Coding (AVC) encoder. More particularly, the disclosure relates to methods and systems for performing faster motion estimation through efficient use of the General Purpose Graphic Processing Unit (GPGPU) as the compute co-processor in a multi-processor architecture.

### BACKGROUND

H.264/AVC (Advanced Video Coding) is a video compression standard that achieves higher compression efficiency than most codecs, but which is very complex to code. One of the most intensive tasks of the AVC encoder is the motion estimation (ME) algorithm. It is a computationally expensive algorithm compared to other video encoding formats as it uses multiple reference frames and multiple block sizes. Even modern single-core CPUs struggle to process high definition (HD) video sequences in real time.

One way to speed up the video encoding process is to use a multi-core architecture, which integrates multiple cores onto a single chip. Another powerful solution is to off-load computationally intensive highly parallel portions of some aspects of the encoding process to the Graphic Processing Unit (GPU), freeing the CPU (in a single-core architecture) or CPUs (in a multi-core architecture) to do more primary system processing.

Using the GPU as a co-processor to the main CPU(s) or host can significantly improve performance for large data processing tasks, but is not without challenges. When developing code for using the GPU, programmers must consider a large number of factors, such as thread block and grid size configuration, GPU occupancy, memory resource allocation and access pattern, and work assignment to threads. The algorithm must be carefully designed to avoid problems like global memory uncoalesced access, thread divergence, warp serialization, shared memory bank conflicts and constant memory conflicts.

The Compute Unified Device Architecture (CUDA) is one example of a hardware and software architecture for issuing and managing computations on the GPU as a data-parallel computing device without the need of mapping them to a graphics API. CUDA is a high level language for GPU programming. In CUDA, a GPU operates as a flexible thread processor, where thousands of computing programs called threads work together to solve complex problems.

Data parallel portions of an application can be executed on the device as CUDA kernels that run many cooperative threads in parallel. The computation is structured as a set of two- or three-dimensional “thread blocks” that run in parallel, and thread blocks in turn are placed in two-dimensional groupings called “grids”. A “kernel” is code executed by a group of threads. The run-time system schedules blocks and grids to run as resources are available. The general computational model is Single Instruction, Multiple Thread (SIMT). The SIMT architecture is similar to the SIMD (Single Instruction, Multiple Data) vector organizations in that a single instruction controls multiple processing elements. SIMT allows programmers to write thread parallel code for independent scalar threads and data-parallel code for cooperative threads whereas SIMD vector organizations expose the SIMD width to the software.

Even in a CUDA-enabled system, there exist challenges when implementing a GPU-based AVC motion estimation algorithm. Multiprocessors in CUDA work in a SIMD fashion, but best performance is achieved when all the core processors perform the same operation at the same time. Divergence among core processors in the same multiprocessor results in serialization of the different paths taken and causes a performance penalty.

Additionally, the CUDA memory model poses a challenge in implementing a GPU-based algorithm. Efficient management of GPU resources is very important for achieving good performance speedups. A multiprocessor can execute one or more thread blocks depending on the usage of shared memory and registers. Higher thread concurrency leads to lower processing time.

There exists a need for methods and systems that perform faster motion estimation through efficient use of the GPGPU as a compute co-processor in multi-processor architectures.

### SUMMARY

The present disclosure includes an exemplary method for performing integer pel motion estimation on a device comprising at least one central processing unit (CPU) and at least one multi-processor graphics processing unit (GPU). In general, the CPU performs some parts of the motion estimation algorithm, while a GPU performs others. In at least one embodiment disclosed herein, the method comprises receiving into a first memory accessible by the GPU, a current picture and one or more reference pictures, the current picture and references pictures comprising multiple 16×16 candidate macroblocks of pixels; receiving into the first memory a set of initial motion vectors; for each candidate macroblock in the current picture, fetching the candidate current and reference macroblock into a second memory; generating an 8×8 sum of absolute differences (SAD) plane based on 8×8 search points for each 8×8 sub-block in the candidate macroblock and the set of initial motion vectors; generating SAD values for each of a set of block sizes for the candidate macroblock; determining a best block size and best motion vector for the best block size for the candidate macroblock to memory; and storing the best block size and the best motion vector for the best block size for the candidate macroblock to a memory accessible by a CPU operatively connected to the GPU.

Also described herein are methods and systems for performing fractional pel motion estimation on a multi-processor graphics processing unit (GPU), the method comprising receiving into memory accessible by the GPU, a current picture and one or more reference pictures, the current picture and references pictures comprising multiple 16×16 candidate macroblocks of pixels; and for each candidate macroblock in the current picture, generating an 8×8 sum of absolute differences (SAD) plane based on a plurality of fractional pel position search point locations in and around an integer pel motion vector for each 8×8 sub-block in the candidate macroblock, generating a 16×16 pixel summed SAD plane based on the block size for the candidate macroblock, determining a best fractional pel motion vector and a final motion vector for the candidate macroblock, and storing a best block size, best motion vector, and best reference frame ID for the best block size for the candidate macroblock.

Further disclosed is an exemplary computer system having at least one central processing unit (CPU) and a graphics processing unit (GPU) for performing motion estimation. In the exemplary system, the CPU receives a current picture and a reference picture, wherein the current picture and the reference picture comprise a plurality of 16×16 macroblocks, each of which comprises four 8×8 sub-blocks, decimates the current and reference pictures to calculate the initial estimate of motion vectors for each 16×16 macroblock in the current picture; determines an initial estimate of motion vectors for the current picture, stores the initial estimate in shared memory, calculates motion estimation vectors for small block sizes, wherein the small block sizes comprises 8×4, 4×8, and 4×4, and stores a best reference frame ID, best block size among small block sizes, and a best motion vector in host memory. The GPU calculates motion estimation vectors for large block sizes, wherein the large block sizes comprises 16×16, 16×8, 8×16, and 8×8, and stores a best reference frame ID, best block size among large block sizes, and a best motion vector in host memory from device memory/global memory. The CPU determines a final best motion vector, final best block size and final best reference frame ID for each macroblock in the current picture based on the best small block size and the best large block size stored in host memory.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments consistent with the invention and together with the description, serve to explain the principles of the invention. In the drawings:

FIG. 1 illustrates an exemplary system for performing the principles of the inventions described herein.

FIG. 2A is a flow chart illustrating an exemplary method for performing motion estimation consistent with the present disclosure.

FIG. 2B shows the process of performing motion estimation for block sizes 16×16, 16×8, 8×16, and 8×8 on the GPU in more detail.

FIG. 3 is a flow chart showing in more detail the process for performing GPU-based integer pel motion estimation consistent with the present disclosure.

FIG. 4A shows an exemplary current picture, with the first 32×32 input block indicated, and an exemplary pattern for fetching sixteen current pixels for use in decimated block matching consistent with the present disclosure.

FIG. 4B shows an exemplary reference picture, with a 32×32 input block corresponding to that in the current picture of FIG. 4A indicated, and an exemplary pattern for fetching sixteen reference pixels for use in decimated block matching consistent with the present disclosure.

FIG. 5 is a flow chart showing an exemplary method for performing fractional pel refinement consistent with the present disclosure.

FIG. 6A shows an example of 16×16 SAD planes.

FIG. 6B shows an example of a summed 8×8 SAD plane as output by the fractional pel second kernel of FIG. 5.

FIG. 7 illustrates the resulting SAD/Motion Vector (MV) values for 16×16 macroblocks of different best block sizes.

### DESCRIPTION OF THE EMBODIMENTS

The following description refers to the accompanying drawings. Wherever possible, the same reference numbers will be used throughout the drawings to refer to the same or similar parts. While several exemplary embodiments and features of the invention are described herein, modifications, adaptations and other implementations are possible without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

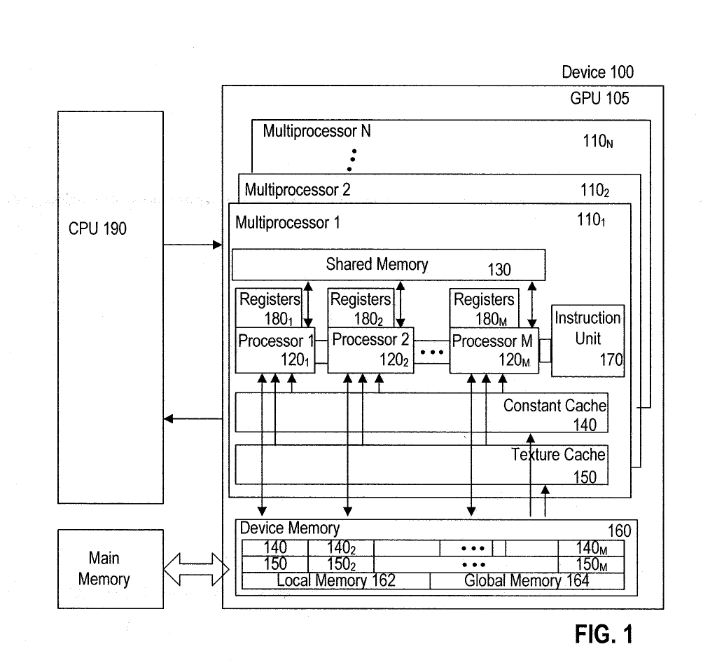

FIG. 1 illustrates an exemplary system for performing the principles of the inventions described herein. FIG. 1 shows a device 100 comprising a GPU 105, device memory 160, CPU 190, and host memory 195, operatively connected by, for example, busses. Although the exemplary system of FIG. 1 is shown with one CPU (host), the principles of the claimed invention may be implemented on systems with multiple CPUs.

Device memory 160 may be, for example, DRAM. Device memory 160 is directly accessible by GPU 105. Host memory 195 (also called “global memory”) is directly accessible by CPU 190. Depending on the configuration, host memory 195 may be operatively connected to the GPU by, for example, a direct memory bus between the GPU, through which data may be transferred between the host memory 195 and the device memory 160. In an integrated GPU, some of host memory 195 may be mapped into an effective address space for GPU 105, making the same memory visible to both the CPU and the GPU, reducing the need to copy from one memory to another for the data to be used by both.

GPU 105 is organized as a bank of N streaming multiprocessors (SM) 110_{1-N}. Each SM 110 has M computing units called a streaming processor (SP). Therefore, GPU 105 has N×M SPs. Each of the SP 120s on a SM 110 is operatively connected to at least one instruction unit 170 for that SM. Each SM may also have one or more special function units (SFU), which are not shown in FIG. 1.

Each SM 110 has a Single Instruction, Multiple Data (SIMD) architecture that executes one instruction on different data concurrently. SMs assign, maintain thread ID numbers, manage and schedule thread execution. Each SM 110 has a parallel data cache, or shared memory 130, that is shared by all the processors (SPs) within an SM. Shared memory is a low latency memory and is ideally, but not necessarily, located near each processor core to further reduce latency. Shared memory allows SPs to share data without the need to pass data outside the chip to the much slower global on-device memory. Use of the embedded shared memory in the GPU reduces the number of external memory accesses.

Each SM 110 has a plurality of local 32-bit registers 180. The number of warps that can reside and be processed together on the multiprocessor for a given kernel depends on the amount of registers and shared memory used by the kernel and the amount of registers and shared memory available on the multiprocessor.

Each SM 110 also has a read-only constant cache 140 that is shared by all the processors and speeds up reads from the constant memory space, which is implemented as a read-only region of device memory 160. Read-only constant cache 140 maps to the constant memory of the device DRAM that is accessible by all SPs.

Each SM 110 also comprises a read-only texture cache that is shared by all the processors and speeds up reads from the texture memory space, which is implemented as a read-only region of device memory. In a CUDA architecture, even though texture memory resides in DRAM, some amount of texture memory space is cached so that a texture fetch costs only one memory read from the device on a cache-miss. Also, the texture cache may be optimized for 2D spatial locality allowing all the threads in a warp to access nearby locations in the texture. Each SM 110 may access the texture cache via a texture unit that implements the various addressing modes and data filtering.

In some architectures, each processor may have one or more local caches, such as the L1/L2 caches currently available on devices of compute capability 2.0. Local cache may be used, for example, to service operations such as load, store, and texture, and can be used to facilitate high speed data sharing across the GPU. In some architectures, on-chip memory may be configurable, such that on-chip memory may be allocated between local cache and shared memory.

Local memory 162 and global memory 164 are implemented as read-write regions of device memory 160 and are not cached. Global memory 164 is both readable and writable by all SPs but lacks cache.

GPU 105 may be any available multi-processor GPU. For example, one exemplary GPU 105 is the NVIDIA GeForce 8600 GT™. It has thirty-two 32-bit processors organized as a bank of four (N=4) SMs, each SM comprising eight (M=8) SPs (or “CUDA Core processors”), two special function units (SFUs), and one warp scheduler. The SFUs provide access to hardware special instructions such as transcendental ops (SIN, COS, LOG, etc). The warp scheduler selects a warp that is ready to execute, if any, and issues the next instruction to the active threads of the warp.

The 8600 GT™ is a SIMT stream processor. In the NVIDIA GeForce 8600 GT™, each SM has 8K registers, 16 KB of shared cache memory, 8 KB of cache working set for constant memory and 6 KB or 8 KB cache working set for texture memory.

Other examples of suitable multi-processor GPUs and their capabilities are shown in the chart below.

| | | | | GeForce |
|---|---|---|---|---|
| | GeForce | GeForce | Quadro | GTX |
| | 8600 GT | GT 240 | FX 5800 | 480 (Fermi) |
| Compute | 1.1 | 1.2 | 1.3 | 2.0 |
| Capability | | | | |
| Streaming | 4 | 12 | 30 | 15 |
| Multiprocessors | | | | |
| (SM) | | | | |
| Processors per | 8 | 8 | 8 | 32 |
| SM | | | | |
| Total Stream | 4 × 8 = 32 | 96 | 240 | 480 |
| Processors | | | | |
| (N × M) | | | | |
| DRAM | 256 MB | 512 MB/1 | 4 GB | 1536 MB |
| | | GB | | GDDR |
| Memory | 128-bit | 128-bit | 512-bit | 384-bit |
| Interface Width | | | | |
| Shared | 16 KB | 16 KB | 16 KB | Configurable, |
| Cache Size/SM | | | | 16 KB or 48 KB |
| Constant | 64 KB | 64 KB | 64 KB | 64 KB |
| Memory Size | | | | |
| 32-bit | 8K | 16K | 16K | 32 |
| registers/SM | | | | |
| Local | 16 KB | 16 KB | 16 KB | 512 KB |
| Memory/thread | | | | |
| L1 Cache | No | No | No | Yes, |
| (on chip memory) | | | | Configurable |
| | | | | along with |
| | | | | shared |
| | | | | memory, |
| | | | | 16 KB or 48 KB |
| L2 cache | No | No | No | Yes, 768 KB |

In the present disclosure, general purpose graphic processing units (GPGPU) are used as the compute co-processor to parallelize the AVC motion estimation algorithm. Certain embodiments will be described herein using terminology associated with the CUDA architecture, however, it is understood by one of ordinary skill in the art that the principles may be applied with other parallel computing architectures and programming languages.

Portions of the AVC motion estimation algorithm may be efficiently parallelized on a GPU using techniques described herein. Shared memory, texture memory and other types of memory are carefully used to achieve maximum parallelism. The GPU-based AVC ME algorithm described herein supports multiple reference frames and multiple block sizes, while achieving good quality (very low peak signal-to-noise ratio (PSNR) degradation) and significant speedup at the same time. The methods described herein are scalable. Therefore, use of GPUs with more core processors and/or more on-chip memory may be used to obtain better performance. The methods described herein are operable in many different working environments ranging from low-end applications like handheld devices and laptops to high-end applications like GPU servers.

The methods described herein achieve improved performance by strategically allocating particular computations of the motion estimation process to the GPU of a device while performing some computations of the motion estimation process on the CPU. Further, enhanced performance is achieved by efficient use of memory. For example, texture memory is allocated for input current picture and reference frames and global/device memory is allocated for the outputs. Static allocation of shared memory is performed inside the kernel function. Constant values are statically allocated in constant memory.

In the H.264/AVC standard, coding of video is performed picture by picture (also called frame by frame in case of progressive pictures or field by field in case of interlaced pictures). Each picture is first partitioned into a number of slices, and each slice is coded independently. A slice consists of a sequence of macroblocks (MB) with each macroblock consisting of 16×16 luminance (Y) and two 8×8 chrominance (Cb and Cr) components. In H.264, a variable MB block size is supported, and 16×16 luminance may be, for example, further partitioned into blocks of 16×16, 8×16, 16×8, and 8×8 pixels. An 8×8 sub-macroblock (or sub-block) may be further partitioned into 8×4, 4×8, and 4×4 blocks. In an AVC encoder, the best motion vectors (MV) of each of the seven block sizes are calculated, which is very complex and time consuming.

### Motion Estimation

Consistent with the present disclosure, the motion estimation stage of the AVC encoding comprises two stages: integer pixel (or pel) motion estimation and fractional pixel (or pel) refinement. Integer pel ME uses full search block matching algorithm (FSBMA). FSBMA produces the best video quality, but is a computationally expensive block matching algorithm. However, FSBMA adapts well to parallel motion estimation because motion vector predictors obtained from previously-coded macroblocks are not needed. Fractional pel motion estimation is also computationally expensive due to the complex sub-pel interpolation process.

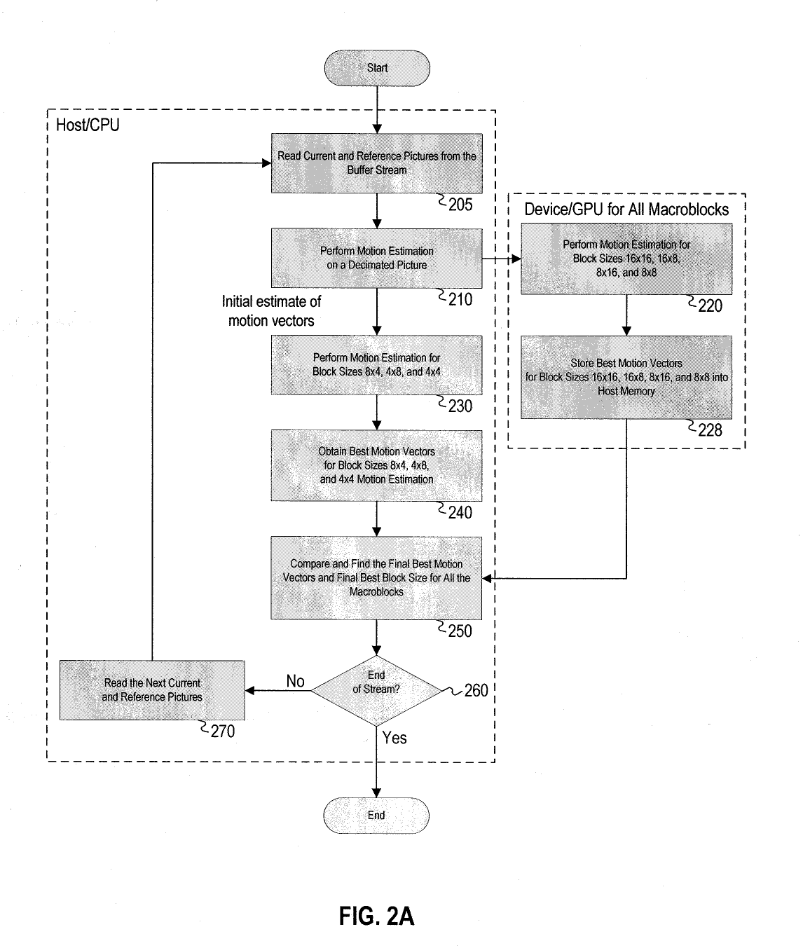

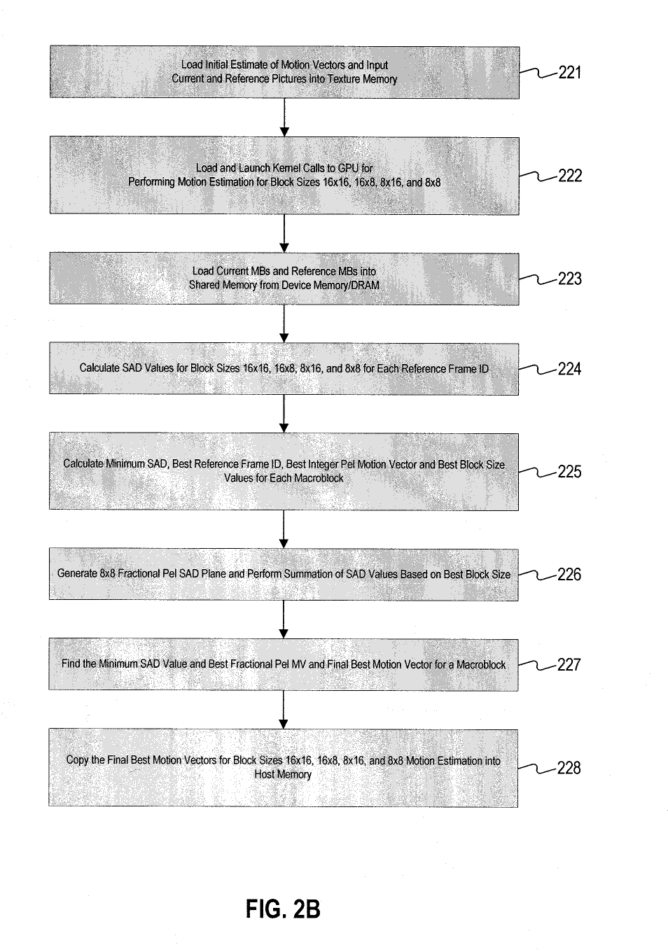

FIG. 2A is a flow chart illustrating an exemplary method of performing motion estimation consistent with the present disclosure. As shown in FIG. 2A, the process begins with the CPU reading a current picture and a reference picture from the buffer stream (step 205). The current and reference pictures are stored in host memory.

In some embodiments, the CPU will perform motion estimation on a decimated picture to get the initial estimate of motion vectors (step 210). This initial estimate of motion vectors is used for further stages of motion estimation for block sizes 16×16, 16×8, 8×16, 8×8, 8×4, 4×8 and 4×4. The set of initial motion vectors comprises one motion vector for each 16×16 macroblock.

In systems consistent with the present disclosure, some steps of integer pel motion estimation and fractional pel refinement will be performed on the CPU and some will be performed using the GPU. For example, as shown in FIG. 2A, the CPU may be used to calculate the motion vectors for 8×4, 4×8, and 4×4 blocks (step 230), and the computations for 16×16, 16×8, 8×16, and 8×8 blocks may be performed by the GPU (step 220).

In this exemplary embodiment, the CPU was chosen to perform motion estimation for block sizes 8×4, 4×8, and 4×4 because these calculations involve simple ALU operations and have a very small data range. Generally speaking, the CPU can calculate these simple operations faster than GPU.

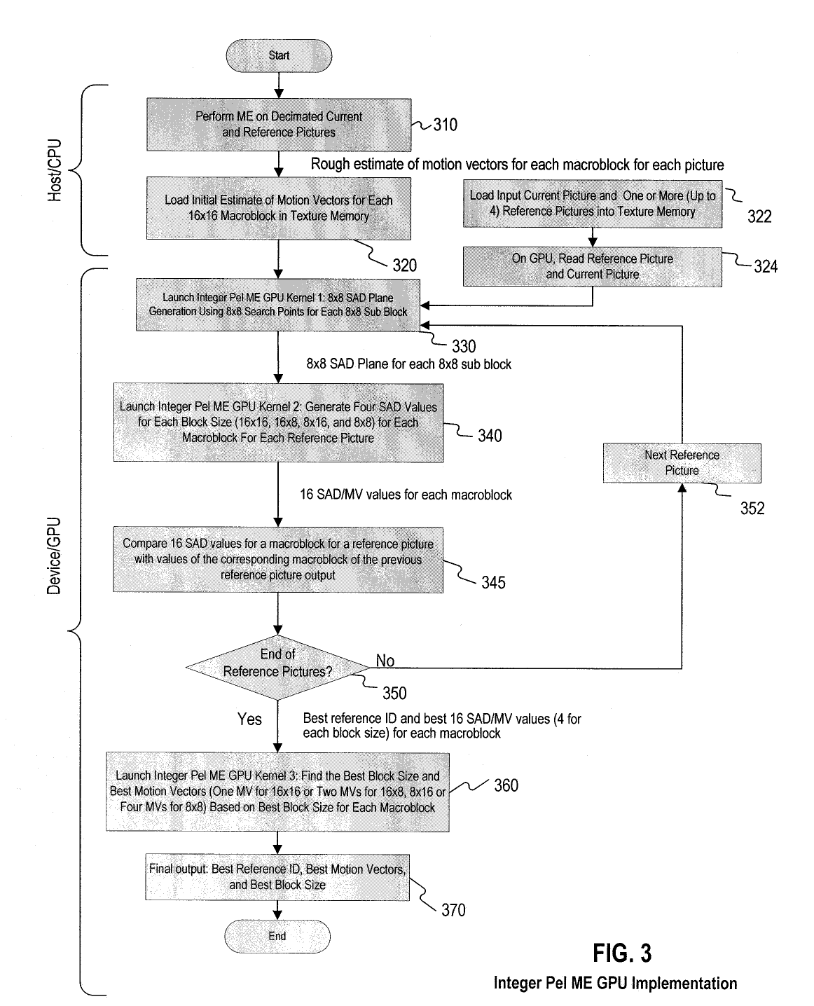

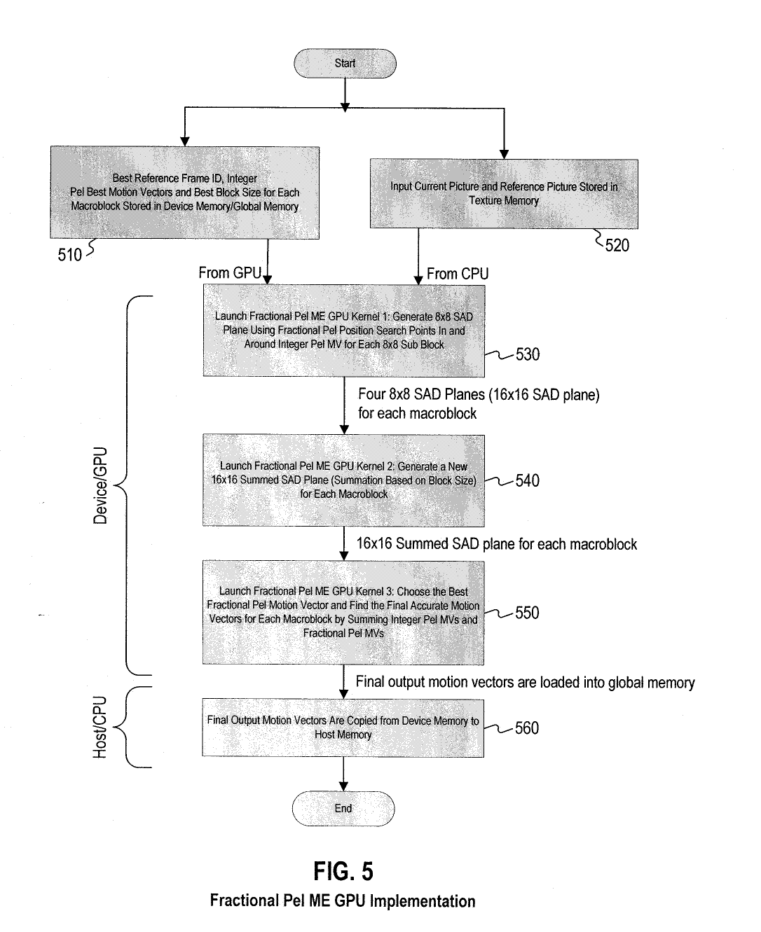

FIG. 2B shows the process of performing motion estimation for block sizes 16×16, 16×8, 8×16, and 8×8 in more detail. As described below with reference to FIGS. 3 and 5, the functions described with reference to blocks 221-228 in FIG. 2B may be performed by, for example, kernel functions.

In general, on the CPU side, the initial estimate of motion vectors is loaded into texture memory of the GPU (step 221). The input current and reference pictures are also loaded into texture memory (step 222).

The original non-decimated current macroblocks and reference macroblocks are loaded into shared memory from texture memory (step 223). Shared memory is an on-chip fast access memory. In embodiments described herein, thread blocks are programmed to fetch corresponding input current and reference 16×16 macroblocks from input current and reference picture data which is available on texture memory or DRAM and loaded into fast access shared memory. A read or write from/to shared memory consumes fewer clock cycles than a read from DRAM/device memory. By reading data that is frequently used during motion estimation, such as the input current and reference macroblocks, from the shared memory, clock cycles may be spared and performance enhanced.

Using the picture data in shared memory, SAD values are calculated on the GPU for block sizes 16×16, 16×8, 8×16, and 8×8 for each reference frame ID (step 224). Minimum SAD values, best reference frame ID, best integer pel motion vector, and best block size values are calculated for each macroblock (step 225). This information is used by the GPU to generate an 8×8 fractional pel SAD plane and perform summation of SAD values based on best block size (step 226). The minimum SAD value and best fractional pel motion vector and final best motion vector for a macroblock will each be determined on the GPU (step 227). When these actions have been completed on the GPU, the final best motion vectors for macroblocks and their best block sizes (16×16 or 16×8 or 8×16 or 8×8) will be stored in host memory 195 (step 228).

As shown in FIG. 2A, the CPU may perform motion estimation for block sizes 8×4, 4×8, and 4×4 (step 230) concurrently with the processing being performed by the GPU. The CPU obtains best motion vectors for macroblocks and their best block sizes (8×4 or 4×8 or 4×4) and stores these motion vectors into host memory 195 (step 240). Once all the best motion vectors are stored in host memory, the CPU may determine the best motion vector and final block size for all macroblocks (step 250).

If the motion estimation process determines that it is at the end of the stream (step 260), motion estimation stops and the information is ready to be used by the next module in the encoder (e.g. motion compensation unit). Otherwise, the next current and reference pictures are read from the buffer stream (step 270) and the process is repeated.

### Kernel Implementations

As mentioned above, the integer pel motion estimation and fractional pel refinement disclosed herein may be implemented as kernel functions. An independent portion of the host code which repeats several times and which operates on different data each time can be a bottleneck for any algorithm. However, such code fragments can be parallelized efficiently. A kernel function may be implemented for handling such bottlenecks on a GPU without affecting the rest of the program. In a CUDA architecture, kernels may be written using a high-level programming language such as C. Kernels can also be written using the PTX (parallel thread execution) instruction set architecture (ISA). PTX provides a stable programming model and instruction set for general purpose parallel programming. Kernels written in C, or other language, may need to be compiled separately into PTX or binary objects, which are optimized for and translated to native target-architecture instructions.

Integer Pel Motion Estimation

In exemplary embodiments consistent with the present disclosure, the integer pel motion estimation performed on the GPU may be implemented as three kernels. A first kernel function generates 8×8 SAD values for each of the four 8×8 sub-blocks in the current picture. A second kernel generates a best motion vector (MV) candidates for each block size (16×16, 16×8, 8×16, 8×8) for each macroblock and for each reference picture and finally determines best motion vector candidates for each block size for a macroblock corresponding to the best reference frame ID for that macroblock. A third kernel determines best block size and best MVs for each macroblock and writes it to global memory along with best reference frame ID so as to be accessed by the fractional pel refinement step in H.264/AVC encoder.

FIG. 3 is a flow chart showing in more detail the process of performing GPU-based integer pel motion estimation consistent with the present disclosure. As shown in FIG. 3, the CPU calculates an initial estimate of motion vectors for each macroblock in the original current picture (step 310). In embodiments consistent with the present disclosure, the CPU may perform motion estimation on a decimated picture to obtain the initial estimate.

The CPU loads the initial estimate of motion vectors for each 16×16 macroblock into texture memory (step 320). The CPU also loads the current input picture and reference pictures into texture memory (step 322). In certain embodiments, the CPU may load multiple reference pictures. In certain embodiments, for example, the maximum number of reference pictures is four. Fewer or more reference pictureses may be used with different results.

To begin processing on the GPU, the GPU reads the current picture and reference picture(s) from texture memory into shared memory (step 324). Next, as shown in FIG. 3, a first kernel may be used to generate an 8×8 SAD plane for each 8×8 sub-block (step 330). To perform the first kernel function, the GPU instantiates a kernel program on a grid of parallel thread blocks. Each thread within a thread block executes an instance of the kernel and has a thread ID within its thread block, a program counter, its own registers, and its own private memory. In the first kernel function, a current macroblock is loaded into shared memory. Thread blocks are designed to read the current macroblock from the current picture in texture memory and then load the macroblock into shared memory.

Since fetching pixels directly from device memory frequently is costly, in embodiments described herein, input data is loaded into shared memory from device memory once and then used from there. Each thread block loads pixels into shared memory region that is accessible only by that thread block.

Thread block configuration used in this kernel is 8×32 and the grid block size for this kernel is determined to be (mb_width/2)×(mb_height/2), where mb_width is the number of macroblocks along the width of the input current picture and mb_height is the number of macroblocks along the height of the input current picture. In the case of a 32×32 pixel input picture and a 16×16 macroblock, mb_width is two and mb_height is two, resulting in a grid size is one.

As mentioned above, the SM manages and schedules thread execution using a warp scheduler. Each thread block is split into warps, each warp comprising up to 32 threads. All threads in a warp will be executed at the same time. The number of clock cycles it takes for a warp to be ready to execute its next instruction is called latency, and full utilization is achieved when the warp scheduler always has some instruction to issue for some warp at every clock cycle during that latency period, or in other words, when the latency of each warp is completely “hidden” by other warps.

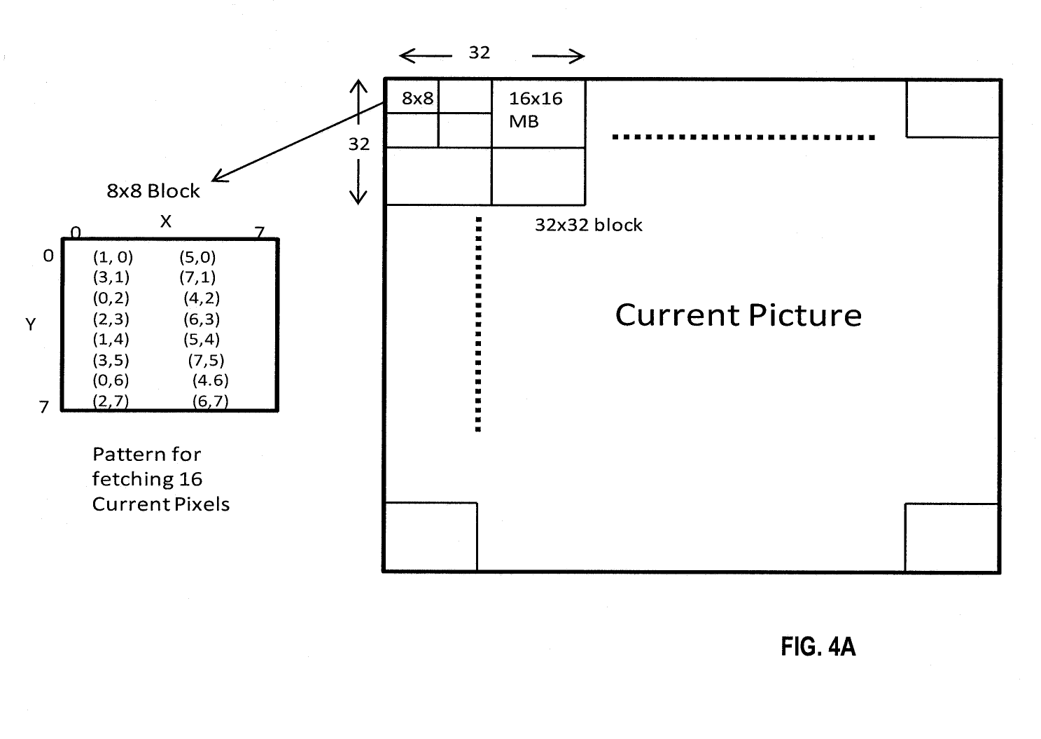

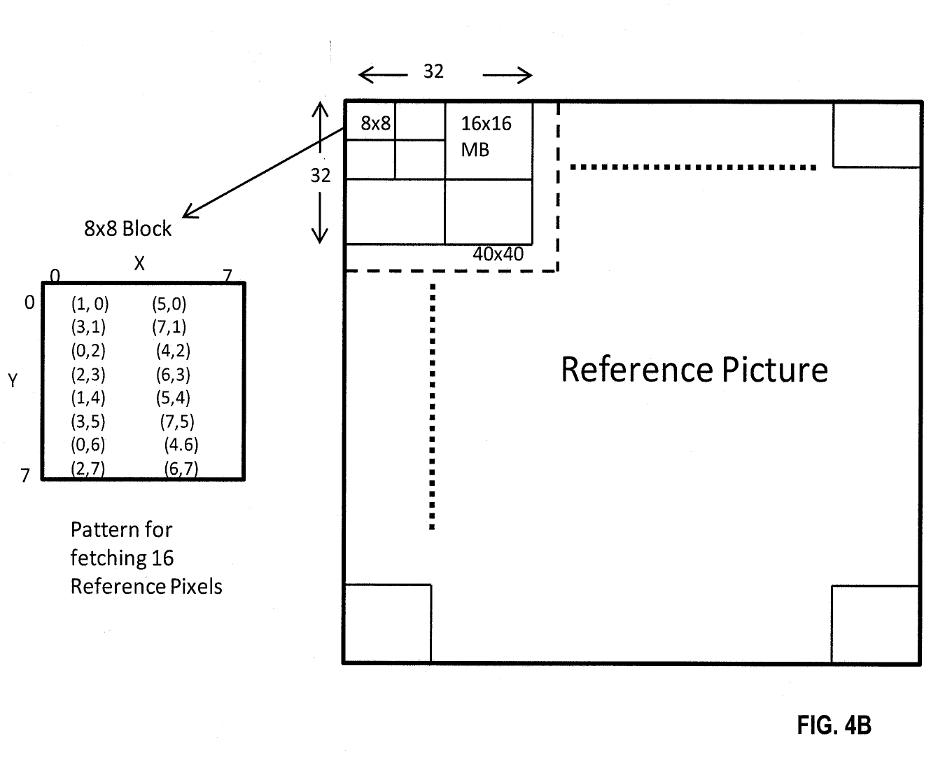

To generate the 8×8 SAD plane for each 8×8 sub-block, embodiments of the GPU-based integer pel motion estimation method described herein use decimated block matching starting from each search point location. In decimated block matching, some number of pixels (less than the full number of 64 pixels in an 8×8 block) is chosen to represent each 8×8 block. In exemplary embodiments described herein, 16 pixels are chosen. FIG. 4A shows an exemplary current picture, with the first 32×32 input block indicated. Also shown in FIG. 4A is an exemplary pattern for fetching 16 current pixels.

The total number of reference pixels required to process sixteen 8×8 sub-blocks (32×32 input block) is 40×40 pixels, as shown in FIG. 4B. In embodiments described herein, one 8×32 thread block processes 32×32 input block i.e., sixteen 8×8 blocks. As in FIG. 4A, sixteen pixels may also be chosen for each 8×8 block in a reference macroblock while performing decimated blocking matching. One exemplary pattern for choosing the representative pixels is shown in FIG. 4B.

The block matching patterns shown in FIG. 4A and FIG. 4B are exemplary only and other patterns may be used. A block matching pattern that selects pixels from a variety of rows and columns and spaced throughout the picture is likely to be most representative of the picture and therefore will likely yield the best results. Additionally, while any block matching pattern may be used, the same block matching pattern should be used for both the current picture and the reference picture. Performing 16-pixel block matching instead of 8×8 block matching starting from the search point location reduces computation complexity and processing time, thereby improving performance without unacceptable or significant degradation of quality.

Sixteen reference pixels may be fetched starting from each of the 8×8 search points in and around the input motion vector location for each 8×8 sub-block. Since some search points and/or pixels accompanying the search point location used for block matching are located on the boundary of the input block, the required reference pixels may be outside a corresponding 32×32 block in the reference picture. In certain embodiments, since the total number of reference pixels required (40×40) is not exactly divisible by the thread block size, one more threads load one or more pixels. While this may result in a slight amount of thread divergence in reference block loading, the impact on overall performance is minimal.

In exemplary block matching patterns described herein, 16 pixels are need for each 8×8 block. Therefore, the total number of current pixels required for processing sixteen 8×8 sub-blocks (assuming a 32×32 input block) is 16×16, or 256, pixels. With a thread block size of 8×32 (or 256 threads), each thread block can process sixteen 8×8 sub-blocks. Hence, in this exemplary embodiment, 16×16 current pixels are loaded into shared memory, with each thread in a thread block loading the information for one pixel. With each thread in a thread block loading one pixel, there is no divergence.

The number of thread blocks that may run concurrently depends at least in part on the size of the shared memory. For example, in this particular embodiment, the amount of shared memory used for storing 16×16 pixels of the current block=16×16×4 bytes=1 KB. The amount of shared memory used for storing the reference block is 40×40 pixels=40×40×4 bytes=6.25 KB. Therefore, in this embodiment, the total amount of shared memory used for current pixels and reference pixels is 1+6.25 KB=7.25 KB. In a device having 16 KB of shared memory or more (like the NVidia GeForce 8600 GT™), at least two thread blocks may be processed simultaneously by one multiprocessor. With two thread blocks running at one time, thirty-two 8×8 sub-blocks—or two 32×32 input blocks—may be processed at the same time on a single multiprocessor. In architectures have more shared memory, it may be possible to run more thread blocks simultaneously which may further improve performance.

The first kernel calculates the sum of absolute difference (SAD) for each 8×8 sub-block (step 330). SAD may be calculated as follows:

$$S A D ( dx , dy ) = {\sum }_{i = 0}^{M - 1} {\sum }_{j = 0}^{N - 1} \vert a ( i , j ) - b ( i + dx , j + dy ) \vert$$

In the equation above, a(i,j) and b(i,j) are the pixels of the reference and candidate or current blocks, respectively. dx and dy are the displacement of the candidate block within the search window. M×N is the size of the reference block/current block.

In order to avoid thread divergence, in this exemplary embodiment, 8×8 search points are used instead of actual search window size of 7×7. In the first step, each set of 8×8 threads within a 8×32 thread block calculates 8×8 SAD values for each of the four 8×8 sub-blocks of a 16×16 pixel macroblock. In other words, one thread calculates four SAD values for a given search point corresponding to four 8×8 sub-blocks. Hence, an 8×32 thread block calculates 32×32 SAD values for sixteen 8×8 sub-blocks (32×32 input block). In exemplary embodiments consistent with this disclosure, there is no thread divergence in SAD block matching step. All the threads are assigned a similar task for calculating SAD values.

With a thread block size of 8×32, each thread block can process sixteen 8×8 sub-blocks. When two thread blocks are run concurrently on a multiprocessor, each SM can process thirty-two 8×8 sub-blocks or two 32×32 input blocks concurrently on a multiprocessor.

In some embodiments, divergence is reduced and shared memory bank conflicts avoided by, for example, using a broadcast mechanism. Shared memory is organized as 32-bit 16 banks. Shared memory bank conflicts occur when one or more threads within a half warp (16 threads) access the same bank. In shared memory broadcast mechanism, all the threads within the same half warp access the same bank. In exemplary embodiments herein, reduced shared memory usage and limited register usage allow the systems to run more than one thread block concurrently on a multiprocessor. The output of the first kernel is stored and used as input for the second kernel.

In some exemplary embodiments, some or all of the output values may be packed into a single 32-bit integer variable. For example, instead of writing SAD value, Manhattan distance, reference frame ID, motion vector X, and motion vector Y as separate 32-bit integer variables, the final output value may be written in the following manner:

|SAD (16 bit, 14 bits+two “zero”)|Manhattan-Distance(8 bit)|refld (2 bit)|MVY(3 bit) |MVX(3 bit)|

Packing bits in this manner saves clock cycles when writing the output into device memory. For example, if each write to device memory takes about 400-500 clock cycles, the amount of latency when writing five 32-bit integer variables to memory is a minimum of 5×400=2000 clock cycles. However, if the output is stored as one—or at least fewer than 5 writes—clock cycles will be saved, and performance may be improved.

In step 340 of the GPU-based integer pel motion estimation, a second kernel may be launched. Kernel 2 generates four SAD/MV packed values for each block size (16×16, 16×8, 8×16, and 8×8), or a total of sixteen SAD/MV packed values for each macroblock.

SAD values for each of block sizes 16×16, 16×8, and 8×16 may be calculated in the second kernel using different combinations of 8×8 sub-block SAD values. This process avoids the need to launch a kernel for each block size. Although kernels run very fast, device kernel invocation is generally more time-consuming than host function calls. Therefore, too many kernel launches result in a performance bottleneck. One kernel function is sufficient to calculate best SADs for all H.264/AVC block sizes.

In the second kernel, the thread block used is 16×16. Grid size is calculated as ((mb_width*mb_height+7)/8)×1, where mb_width equals the number of macroblocks along the width of the input current picture and mb_height is the number of macroblocks along the height of the input current picture.

One thread block processes eight 16×16 SAD/MV packed value blocks. This thread block loads 8×16×16 SAD/MV packed values into shared memory from device/global memory so as to reduce frequent reads from device memory. One thread loads eight SAD/MV packed values into shared memory. There is no divergence in loading these values.

In a first step of the second kernel, only 7×7 valid SAD/MV packed values for an 8×8 sub-block are considered when determining minimum SAD position. The rest of the SAD/MV packed values may be ignored. One thread block processes eight 16×16 (32 8×8 blocks) SAD blocks and outputs 32 minimum SAD position values. One or more threads participate in calculating minimum SAD positions.

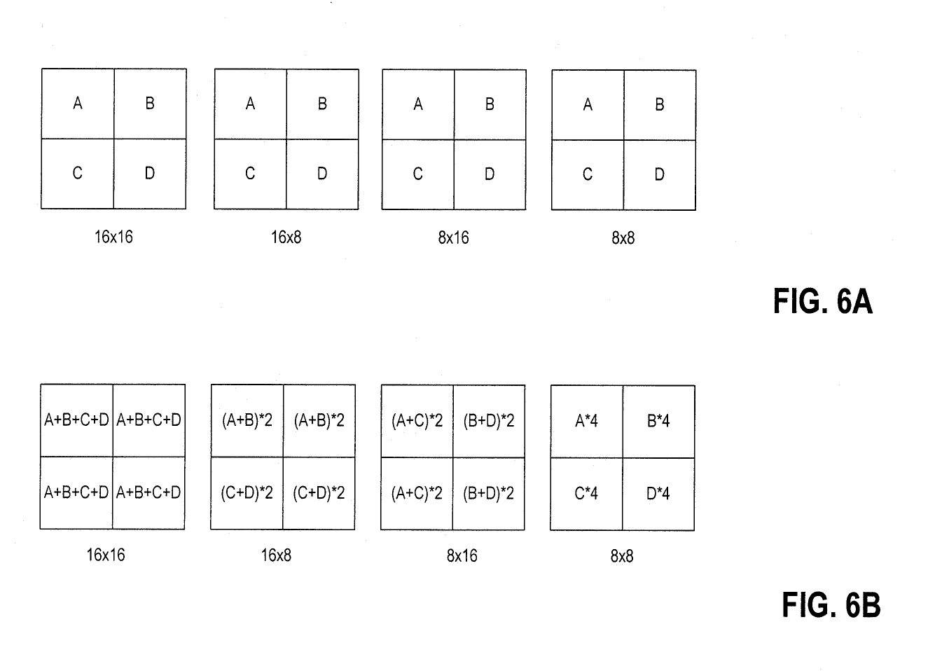

As a result of the first step, four minimum SAD positions are determined for each macroblock, corresponding to four 8×8 sub-blocks, as shown in FIG. 6A. In a second step, the different combinations of SAD values at these four minimum SAD positions may be summed to generate four new minimum SAD/MV packed values for each of the block sizes 16×16, 16×8, 8×16 and 8×8 for a macroblock. In this embodiment, only 32 threads out of 256 threads participate in this task, and there may be slight divergence.

The output of the second kernel is sixteen SAD/MV packed values (four SAD values for each block size corresponding to four 8×8 sub-blocks) for a given macroblock. Hence, a total of 16×8 SAD/MV packed values are generated for eight macroblocks. In this exemplary embodiment, 16×8 threads in a thread block participate in writing 16×8 SAD/MV packed values into global memory. Since all the threads within four warps (16×8/32 threads=4 warps) perform the same task, there is no thread divergence.

If more than one reference picture is being used, only the best sixteen SAD/MV packed values for a macroblock will be stored. Therefore, to determine the best values, in step 346, the current sixteen SAD/MV packed values are compared with the sixteen SAD/MV packed values for a previous reference picture (if there was one). If the current values are better, the current sixteen SAD/MV packed values will be stored.

If there are more than one reference picture for a given current picture (step 350), the process continues with the next reference picture (step 352). The two kernels described above (steps 330 and 340) and step 345 may be repeated for all of the reference pictures in the buffer stream so as to find the best reference ID for each macroblock. The final total of best sixteen SAD/MV packed values (four new minimum SAD/MV packed values for each of the block sizes 16×16, 16×8, 8×16 and 8×8) are determined for each macroblock corresponding to the best reference picture for that macroblock. Best Reference ID and final 16 SAD/MV packed output values for eight macroblocks of this kernel are updated in the global memory which is later used in the next kernel.

As shown in FIG. 3, in step 360, a third kernel may be launched to perform the next step of the integer pel motion estimation. Kernel three determines the best block size and best motion vectors for each macroblock of the reference picture. One thread block loads sixteen sets of sixteen minimum SAD/MV packed values for sixteen macroblocks, that is, sixteen minimum SAD/MV packed values for each 16×16 macroblock into shared memory. One thread block finds the best block size for each of the sixteen 16×16 macroblocks and outputs the best motion vectors for each macroblock. For the 16×16 best block size macroblock, one best motion vector will be chosen. For the 16×8 and 8×16 best block size macroblocks, two best motion vectors will be chosen. And for the 8×8 best block size macroblock, four best motion vectors are chosen.

For this kernel, the thread block size is 16×16. Grid size is calculated as ((mb_width+mb_height+15)/16)×1, where mb_width is the number of macroblocks along the width of the input current picture, and mb_height is number of macroblocks along the height of the input current picture.

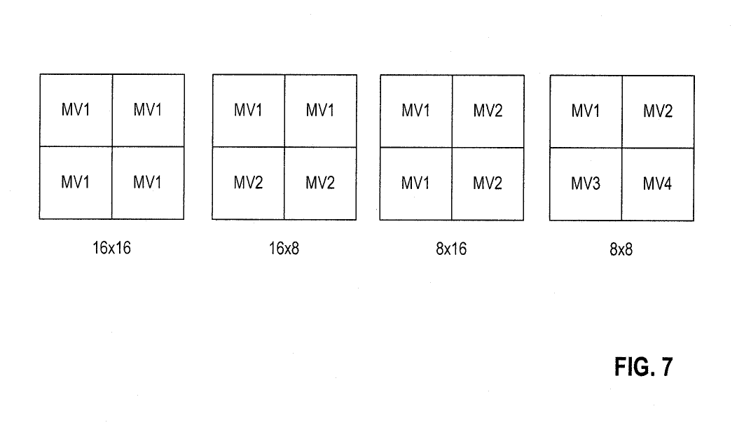

This kernel outputs a total of sixteen block sizes and 16×4 best motion vectors (best motion vectors assigned for four 8×8 sub-blocks as shown in FIG. 7 depending on the best block size) corresponding to sixteen macroblocks. These values are stored by 16 threads writing 16 best block sizes corresponding to 16 macroblocks into device/global memory. This is the final motion vector output for GPU based motion estimation algorithm for large block sizes 16×16, 16×8, 8×16 and 8×8.

In the exemplary embodiment, 16×4 threads out of 16×16 threads write 16×4 best motion vectors into device/global memory. Since all the threads within the warps perform the same task, there is no divergence.

Finally, the best reference ID, best motion vectors, and best block sizes are stored into device/global memory (step 370).

Fractional Pel Refinement

In methods and systems consistent with the present disclosure, integer pel motion vectors may be further refined to fractional pel accuracy. One exemplary method for performing fractional pel refinement is discussed with reference to FIG. 5. Fractional pel refinement results in more accurate motion vectors and less prediction error. As described below, one exemplary fractional pel ME algorithm consistent with the present disclosure uses full search block matching and uses 7×7 search window (top to bottom: −0.75 to +0.75 and left to right: −0.75 to +0.75, 49 search points) in and around the integer pel motion vector. To avoid divergence, SAD values may be calculated for 8×8 search points. SAD values corresponding to invalid points may be ignored later.

In exemplary embodiments, the fractional pel refinement process may use the outputs from the integer pel motion estimation process described above. For example, as a result of the integer pel motion estimation process described above, a best reference frame ID, integer pel best motion vectors, and best block size for each macroblock is determined and stored in device memory/global memory (step 510).

In step 520, a current picture and reference picture are stored in texture memory by the CPU (step 520).

In embodiments consistent with the present disclosure, the reference picture may be stored in texture memory with a bi-linear interpolation feature enabled. In a GPU, bilinear interpolation is significantly faster than the manual H.264 6-tap GPU implementation with less quality degradation. CUDA systems provide a built-in bi-linear interpolation feature. In exemplary embodiments described herein, fractional pel motion estimation is performed at quarter-pel resolution. Other embodiments may use other resolutions.

In accordance with the present disclosure, fractional pel refinement may be implemented using three kernels as shown in FIG. 5. A first kernel (step 530) generates a 16×16 SAD plane (four 8×8 SAD planes) for each 16×16 macroblock. A second kernel (step 540) performs intermediate summation of SAD values based on best block size. A third kernel (step 550) chooses the best fractional pel motion vector depending on minimum SAD value.

For the first kernel of the fractional pel refinement, thread block size is 8×8. Grid block size is calculated as (mb_width×2)×(mb_height×2), where mb_width is the number of macroblocks along the width of the input current picture and mb_height is the number of macroblocks along the height of the input current picture. One 8×8 thread block processes one 8×8 sub-block.

Inputs to the first kernel include the integer pel motion vectors determined as using integer pel ME, the current picture, and a reference picture.

In some embodiments, the input reference picture is a bi linear interpolated picture. If, for example, texture linear filtering is enabled, the pixels may be fetched from the reference picture using fractional positions, which will internally interpolate the pixels resulting in a bi-linear interpolated picture.

To begin, the current block is loaded into shared memory. One 8×8 thread block loads an 8×8 current pixel sub-block into shared memory. Each thread loads one pixel. In this embodiment, there is no thread divergence.

A reference block is also loaded into shared memory. The total number of fractional reference pixels required to process one 8×8 current block is 36×36 (pixels at fractional locations). But, in embodiments consistent with the present disclosure, each 8×8 thread block loads 40×40 reference pixels to avoid divergence. Each thread loads 25 fractional reference pixels (40×40/8×8=25) from texture memory with bi-linear interpolation feature enabled. Reference pixels are loaded carefully so as to avoid shared memory bank conflicts.

As in integer pel motion estimation above, an 8×8 search window size is used instead of a 7×7 window in order to avoid divergence. One 8×8 thread block processes 8×8 search points and outputs 8×8 SAD values. The 8×8 SAD values are stored in device/global memory. Each thread is assigned the task of processing one search point. In this exemplary embodiment, no threads are idle and all the threads perform the same task. In this exemplary embodiment, there is no divergence.

The first kernel of fractional pel refinement outputs an 16×16 SAD matrix of values for each 16×16 macroblock as shown in FIG. 6A. The SAD values are stored in device memory.

The fractional pel refinement continues with a call to a second kernel that performs intermediate summation based on best block size (step 540). For the second kernel, the thread block size is determined to be 16×16. Grid size is calculated to be mb_width×mb_height, where mb_width is the number of macroblocks along the width of the input current picture and mb_height is the number of macroblocks along the height of the input current picture.

The input to the second kernel of the fractional pel refinement is the 16×16 SAD matrix of values generated as output of the first kernel and the best block size for each macroblock. Each thread block of size 16×16 performs summation of SAD values depending on best block size for a 16×16 SAD matrix and produces a new 16×16 SAD plane (matrix) as shown FIG. 6B. In this step, SAD values corresponding to the invalid search points (8×8 search points—7×7 valid search points=15 invalid search points) may be assigned very high values so that they can be ignored in the next kernel while determining minimum SAD value position. The final new 16×16 SAD plane output is written to device memory. This is provided as the input to the fractional pel ME third kernel.

In step 550, a third kernel determines the best fractional pel motion vector for a macroblock and determines the final accurate motion vectors for each macroblock. For the third kernel, the thread block size is determined to be 16×16. Grid size is determined to be ((mb_width*mb_height+7)/8)×1 where mb_width is the number of macroblocks along the width of the input current picture and mb_height is the number of macroblocks along the height of the input current picture.

In this exemplary embodiment, the input to the third kernel is the summed SAD plane (stored in device memory) that is the output of the second kernel. One thread block processes eight 16×16 input summed SAD blocks (or 32 8×8 sub-blocks). One thread block loads 16×16 summed SAD values corresponding to eight macroblocks into shared memory i.e., 8×16×16 values from device memory. One thread loads eight values. In this exemplary embodiment, there is no divergence in loading.

Minimum SAD position value may be calculated for each 8×8 sub-block. One or more threads participate in determining minimum SAD position. One thread block process eight 16×16 SAD blocks and outputs 32 minimum SAD/MV position values corresponding to 32 8×8 sub-blocks. In this exemplary embodiment, there may be slight divergence.

In step 550, previously-determined integer pel motion vectors may be added to the fractional pel motion vector to get the final best motion vector for each 8×8 sub-block. The best fractional pel motion vector and final accurate motion vectors for each 8×8 sub-block of a 16×16 macroblock are determined based on this sum.

In this embodiment, 32 threads participate in writing 32 output values into device/global memory which is later copied back to host memory (step 560). As described above, some or all of the output values may be packed into a single 32-bit integer variable to save clock cycles.

For purposes of explanation only, certain aspects and embodiments are described herein with reference to the components illustrated in FIG. 1. The functionality of the illustrated components may overlap, however, and may be present in a fewer or greater number of elements and components. For example, although exemplary embodiments were described using a specific number of kernels, more or fewer kernels may be used to achieve the same results. Further, all or part of the functionality of the illustrated elements may co-exist or be distributed among several different devices and/or at geographically-dispersed locations. Moreover, embodiments, features, aspects and principles of the present invention may be implemented in various environments and are not limited to the illustrated environments.

Further, the sequences of events described in FIGS. 2A, 2B, 3, and 5 are exemplary and not intended to be limiting. Thus, other method steps may be used, and even with the methods depicted in these figures, the particular order of events may vary without departing from the scope of the present invention. Moreover, certain steps may not be present and additional steps may be implemented. Also, the processes described herein are not inherently related to any particular apparatus and may be implemented by any suitable combination of components.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of performing integer pel motion estimation on a device comprising at least one central processing unit (CPU) and at least one multi-processor graphics processing unit (GPU), the method comprising:
receiving into a first memory accessible by the GPU, a current picture and one or more reference pictures, the current picture and references pictures comprising multiple 16×16 candidate macroblocks of pixels;
receiving into the first memory a set of initial motion vectors;
for each candidate macroblock in the current picture,
fetching the candidate current and reference macroblock into a second memory;
generating an 8×8 sum of absolute differences (SAD) plane based on 8×8 search points for each 8×8 sub-block in the candidate macroblock and the set of initial motion vectors;
generating SAD values for each of a set of block sizes for the candidate macroblock;
determining a best block size and best motion vector for the best block size for the candidate macroblock to memory; and
storing the best block size and the best motion vector for the best block size for the candidate macroblock to a memory accessible by a CPU operatively connected to the GPU.

2. The method of claim 1, wherein the GPU comprises at least thirty-two processors, and step of fetching the candidate macroblock into a second memory comprises:
configuring a thread block of size 8×32;
concurrently fetching all pixels of the candidate current macroblock using 256 threads, each thread fetching one pixel.
fetching all the required pixels of the candidate reference macroblock using 8×33 thread block, one or more threads loading one or more pixels.

3. The method of claim 2, wherein the first memory is device memory or DRAM and the second memory is shared memory.

4. The method of claim 1, wherein the set of initial motion vectors comprises one motion vector for each 16×16 macroblock.

5. The method of claim 1, wherein the set of initial motion vectors is generated by the CPU based on decimated pictures.

6. The method of claim 1, wherein generating an 8×8 sum of absolute differences (SAD) plane based on 8×8 search points for each 8×8 sub-block in the candidate macroblock and the set of initial motion vectors comprises:
performing block matching starting from each search point location.

7. The method of claim 6, wherein the block matching is performed on fewer pixels than 64 pixels between 8×8 current and reference sub-blocks.

8. The method of claim 7, wherein the current and reference blocks comprise sixteen pixels for each 8×8 sub-block fetched from the first memory in a particular block matching pattern, the same pattern for the current block and the reference block.

9. The method of claim 8, wherein the input block is 32×32, and an 8×8 SAD plane is generated for each 8×8 sub-block in the input block.

10. The method of claim 1, wherein the set of block sizes comprises four block sizes (16×16, 16×8, 8×16, 8×8) and wherein generating SAD values for each of the set of block sizes for the candidate macroblock comprises:
configuring a thread block of size 16×16;
loading eight 16×16 SAD/MV packed value blocks into shared memory with one thread loading eight SAD/MV packed values into shared memory;
determining 32 minimum SAD position values, one SAD position value per 8×8 block in the candidate macroblock; and
determining four minimum SAD/MV values representing the macroblock.

11. The method of claim 10, wherein the step of determining 32 minimum SAD position values further comprises choosing minimum SAD position value from 7×7 SAD/MV packed values only for each 8×8 SAD/MV block and ignoring invalid search points, one SAD position value per 8×8 block in the candidate macroblock.

12. The method of claim 10, wherein the step of determining four minimum SAD/MV values representing the macroblock comprises determining a minimum SAD/MV values for each of the four block sizes.

13. The method of claim 1, further comprising determining a best reference frame ID for each candidate macroblock.

14. The method of claim 13, wherein determining a best block size and best integer pel motion vector for the best block size for the candidate macroblock comprises:
concurrently loading one of minimum SAD position values for each macroblock, with one thread loading one value;
determining the best block size for each of the candidate macroblocks; and
outputting the best block sizes, best integer pel motion vector and best reference frame ID for each of the candidate macroblocks.

15. A method of performing fractional pel motion estimation on a multi-processor graphics processing unit (GPU), the method comprising:
receiving into memory accessible by the GPU, a current picture and one or more reference pictures, the current picture and references pictures comprising multiple 16×16 candidate macroblocks of pixels; and for each candidate macroblock in the current picture,
generating an 8×8 sum of absolute differences (SAD) plane based on a plurality of fractional pel position search point locations in and around an integer pel motion vector for each 8×8 sub-block in the candidate macroblock,
generating a 16×16 pixel summed SAD plane based on the block size for the candidate macroblock,
determining a best fractional pel motion vector and a final motion vector for the candidate macroblock, and
storing a best block size, best motion vector, and best reference frame ID for the best block size for the candidate macroblock.

16. The method of claim 15, wherein determining a best fractional pel motion vector and a final motion vector for the candidate macroblock comprising summing fractional pel motion vectors for the candidate macroblock with previously-determined integer pel motion vectors for the same candidate macroblock.

17. The method of claim 15, wherein generating an 8×8 sum of absolute differences (SAD) plane based on a plurality of fractional pel position search points comprises:
for each 8×8 sub-block in the candidate macroblock,
loading an 8×8 current pixel sub-block per thread block into shared memory;
loading 40×40 reference pixels at corresponding fractional pel positions into the shared memory with each thread block loading 25 fractional reference pixels;
processing 8×8 search points in the candidate macroblock, with one thread processing one search point; and
determining 8×8 SAD values for the candidate macroblock.

18. In a computer system having at least one central processing unit (CPU) and a graphics processing unit (GPU), a method of performing motion estimation, the method comprising:
the CPU
receiving a current picture and a reference picture, wherein the current current picture and the reference picture comprise a plurality of 16×16 macroblocks, each of which comprises four 8×8 sub-blocks,
decimating the current and reference pictures to calculate the initial estimate of motion vectors for each 16×16 macroblock in the current picture;
determining an initial estimate of motion vectors for the current picture, and storing the initial estimate in shared memory, and
calculating motion estimation vectors for small block sizes, wherein the small block sizes comprises 8×4, 4×8, and 4×4, and
storing a best reference frame ID, best block size among small block sizes, and a best motion vector in host memory; and
the GPU
calculating motion estimation vectors for large block sizes, wherein the large block sizes comprises 16×16, 16×8, 8×16, and 8×8, and
storing a best reference frame ID, best block size among large block sizes, and a best motion vector in host memory from device memory/global memory;
and
the CPU
determining a final best motion vector, final best block size and final best reference frame ID for each macroblock in the current picture based on the best small block size and the best large block size stored in host memory.
